(19) United States
(12) Patent Application Publication
(10) Pub. No.: US 2025/0179862 A1
(43) Pub. Date: Jun. 5, 2025

(54) APPARATUS FOR CONTROLLING VEHICLE, SYSTEM INCLUDING SAME, AND METHOD THEREOF

(71) Applicants: HYUNDAI MOTOR COMPANY, Seoul (KR); Kia Corporation, Seoul (KR)

(72) Inventors: Jong Kug CHOI, Hwaseong-si (KR); Yong Min KWON, Suwon-si (KR); Sang Hun LEE, Hwaseong-si (KR)

(73) Assignees: HYUNDAI MOTOR COMPANY, Seoul (KR); Kia Corporation, Seoul (KR)

(21) Appl. No.: 18/789,282

(22) Filed: Jul. 30, 2024

(30) Foreign Application Priority Data
Dec. 4, 2023 (KR) 10-2023-0173611

(51) Int. Cl. E05F 15/76

(52) U.S. Cl. CPC E05F 15/76; E05Y 2900/531; E05Y 2900/536; E05Y 2900/548

(57) ABSTRACT

In a vehicle control apparatus, a system including the same, and a method thereof, the vehicle control apparatus may include a communication circuit and a processor. The processor is configured to determine whether an external electronic device is located in a surrounding area formed within a specified distance from a vehicle, based on receiving data associated with a location of the external electronic device from the external electronic device, through the communication circuit and may execute a function, which corresponds to a specified area and which is associated with control of the vehicle, based on a fact that the external electronic device is located in the specified area of the surrounding area, and a user input to a button included in the external electronic device is maintained for a specified time or longer than the specified time.

### CROSS-REFERENCE TO RELATED APPLICATION

The present application claims priority to Korean Patent Application No. 10-2023-0173611, filed on Dec. 4, 2023, the entire contents of which is incorporated herein for all purposes by this reference.

### BACKGROUND OF THE PRESENT DISCLOSURE

### Field of the Present Disclosure

The present disclosure relates to a vehicle control apparatus, a system including the same, and a method thereof, and more particularly to a technology for executing different functions depending on a relative location of a smart key with respect to a vehicle.

### Description of Related Art

Nowadays, a one-button type smart key is being developed. Because a user input is entered into on only a single button, the one-button type smart key may control a vehicle and/or vehicle control device through a combination of commands for the single button.

To perform various functions by use of one button, it is necessary for a user to identify a command corresponding to each of the various functions, to memorize the command, and to apply the command.

Moreover, as the number of commands corresponding to each of the various functions increases, the number of mis-inputs of a user may increase, and the user may not execute the desired function immediately.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle control apparatus that executes different functions depending on a relative location of an external electronic device with respect to a vehicle, a system including the same, and a method thereof.

Various aspects of the present disclosure are directed to providing a vehicle control apparatus that executes different functions depending on a relative location of the external electronic device with respect to the vehicle, and an input to a button included in the external electronic device, a system including the same, and a method thereof.

Various aspects of the present disclosure are directed to providing a vehicle control apparatus that provides a notification of a function performed if a user input to a location of the external electronic device, and a button included in the external electronic device is generated, a system including the same, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control apparatus may include a communication circuit and a processor. The processor is configured to determine whether an external electronic device is located in a surrounding area formed within a predetermined distance from a vehicle, based on receiving data associated with a location of the external electronic device from the external electronic device, through the communication circuit and may execute a function, which corresponds to a predetermined area and which is associated with control of the vehicle, based on a fact that the external electronic device is located in the predetermined area of the surrounding area, and a user input to a button included in the external electronic device is maintained for a predetermined time or longer than the predetermined time.

According to an exemplary embodiment of the present disclosure, the processor may cause a headlamp of the vehicle to blink based on the external electronic device being located in a first predetermined area corresponding to a front of the vehicle in the surrounding area and may execute a first function of causing a frunk of the vehicle to be opened.

According to an exemplary embodiment of the present disclosure, the processor may cause a tail lamp of the vehicle to blink based on the external electronic device being located in a second predetermined area corresponding to a rear of the vehicle in the surrounding area, and may execute a second function of causing a trunk of the vehicle to be opened.

According to an exemplary embodiment of the present disclosure, the processor may cause at least one of a right side mirror lamp included in a side mirror of the vehicle, or a lamp located on a right side surface of the vehicle, or any combination thereof to blink based on the external electronic device being located in a third predetermined area, which corresponds to a right side of the vehicle, in the surrounding area, and may execute a third function of causing a right door of the vehicle to be opened.

According to an exemplary embodiment of the present disclosure, the processor may cause at least one of a left side mirror lamp included in a side mirror of the vehicle, or a lamp located on a left side surface of the vehicle, or any combination thereof to blink based on the external electronic device being located in a fourth predetermined area, which corresponds to a left side of the vehicle, in the surrounding area, and may execute a fourth function of causing a left door of the vehicle to be opened.

According to an exemplary embodiment of the present disclosure, the processor may cause at least one light-emitting diode (LED) included in the external electronic device to blink based on identifying that the external electronic device moves from the surrounding area to an area different from the surrounding area.

According to an exemplary embodiment of the present disclosure, the processor may cause the at least one LED blinking at a first period to blink at a second period different from the first period based on identifying the moving.

According to an exemplary embodiment of the present disclosure, the processor may cause the at least one LED emitting light in a first color to emit light in a second color different from the first color based on identifying the moving.

According to an exemplary embodiment of the present disclosure, the processor is configured to output a guide sound indicating that the external electronic device moves from the surrounding area to an area different from the surrounding area, through a speaker included in the vehicle based on identifying that the external electronic device moves from the surrounding area to the area different from the surrounding area.

According to an aspect of the present disclosure, a vehicle control system may include a vehicle control apparatus included in a vehicle, and an external electronic device including a smart key. The vehicle control apparatus may include a first communication circuit that establishes a communication link with the external electronic device, and a first processor. The external electronic device may include a second communication circuit that establishes a communication link with the vehicle control apparatus, at least one light emitting diode (LED), a button, and a second processor. The second processor is configured to transmit data indicating a location of the external electronic device to the vehicle control apparatus through the second communication circuit, and may turn on the at least one LED for indicating that the external electronic device enters a surrounding area formed within a predetermined distance from the vehicle, based on receiving a signal for causing the at least one LED to be turned on from the vehicle control apparatus. The first processor is configured to determine whether the external electronic device is located in a predetermined area of the surrounding area, based on receiving data indicating the location of the external electronic device through the first communication circuit, and may execute a function, which corresponds to the predetermined area and which is associated with control of the vehicle, based on a fact that the external electronic device is located in the predetermined area, and a user input to the button is maintained for a predetermined time or longer than the predetermined time.

According to an exemplary embodiment of the present disclosure, the predetermined area may include a first predetermined area corresponding to a front of the vehicle, a second predetermined area corresponding to a rear of the vehicle, a third predetermined area corresponding to a right side of the vehicle, and a fourth predetermined area corresponding to a left side of vehicle.

According to an exemplary embodiment of the present disclosure, the function associated with the control of the vehicle may include a first function that causes a headlamp of the vehicle to be turned on and causes a frunk of the vehicle to be opened, a second function that causes a tail lamp of the vehicle to be turned on and causes a trunk of the vehicle to be opened, a third function that causes at least one of a right side mirror lamp included in a side mirror of the vehicle, or a lamp located on a right side surface of the vehicle, or any combination thereof to be turned on, and causes a right door of the vehicle to be opened, and a fourth function that causes at least one of a left side mirror lamp included in a side mirror of the vehicle, or a lamp located on a left side surface of the vehicle, or any combination thereof to be turned on, and causes a left door of the vehicle to be opened.

According to an exemplary embodiment of the present disclosure, the first processor may identify that the external electronic device moves from the surrounding area to an area different from the surrounding area, based on data indicating the location of the external electronic device, through the first communication circuit, and may transmit a signal for causing a change in a period, at which the at least one LED included in the external electronic device blinks, to the external electronic device based on identifying the moving. The second processor may change the period, at which the at least one LED blinks, from a first period to a second period based on receiving the signal for causing the change in the period, at which the at least one LED blinks.

According to an aspect of the present disclosure, a vehicle control method may include determining, by a processor, whether an external electronic device is located in a surrounding area formed within a predetermined distance from a vehicle, based on receiving data associated with a location of the external electronic device from the external electronic device, through a communication circuit, and executing a function, which corresponds to the predetermined area and which is associated with control of the vehicle, based on a fact that the external electronic device is located in the predetermined area, and a user input to the button is maintained for a predetermined time or longer than the predetermined time.

According to an exemplary embodiment of the present disclosure, the vehicle control method may further include causing a headlamp of the vehicle to blink based on the external electronic device being located in a first predetermined area corresponding to a front of the vehicle in the surrounding area, and executing a first function of causing a frunk of the vehicle to be opened.

According to an exemplary embodiment of the present disclosure, the vehicle control method may further include causing a tail lamp of the vehicle to blink based on the external electronic device being located in a second predetermined area corresponding to a rear of the vehicle in the surrounding area, and executing a second function of causing a trunk of the vehicle to be opened.

According to an exemplary embodiment of the present disclosure, the vehicle control method may further include causing at least one of a right side mirror lamp included in a side mirror of the vehicle, or a lamp located on a right side surface of the vehicle, or any combination thereof to blink based on the external electronic device being located in a third predetermined area, which corresponds to a right side of the vehicle, in the surrounding area, and executing a third function of causing a right door of the vehicle to be opened.

According to an exemplary embodiment of the present disclosure, the vehicle control method may further include causing at least one of a left side mirror lamp included in a side mirror of the vehicle, or a lamp located on a left side surface of the vehicle, or any combination thereof to blink based on the external electronic device being located in a fourth predetermined area, which corresponds to a left side of the vehicle, in the surrounding area, and executing a fourth function of causing a left door of the vehicle to be opened.

According to an exemplary embodiment of the present disclosure, the vehicle control method may further include causing at least one LED included in the external electronic device to blink based on identifying that the external electronic device moves from the surrounding area to an area different from the surrounding area.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 shows an example of a block diagram associated with a vehicle control apparatus, according to an exemplary embodiment of the present disclosure;

FIG. 2 shows an example of a block diagram associated with a vehicle control system, according to an exemplary embodiment of the present disclosure;

FIG. 3 shows an example of a surrounding area of a vehicle, and a specified area of the surrounding area, according to an exemplary embodiment of the present disclosure;

FIG. 4 shows an example of a flowchart associated with a vehicle control method, according to an exemplary embodiment of the present disclosure;

FIG. 5 shows an example of a flowchart associated with a vehicle control method, according to an exemplary embodiment of the present disclosure;

FIG. 6 shows an example of a flowchart associated with a vehicle control method, according to an exemplary embodiment of the present disclosure;

FIG. 7 shows an example of a signal flowchart associated with signals transmitted and/or received between a vehicle control apparatus and an external electronic device, according to an exemplary embodiment of the present disclosure; and

FIG. 8 shows an example of a computing system associated with a vehicle control apparatus or vehicle control method, according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding reference numerals to components of each drawing, it should be noted that the same components include the same reference numerals, although they are indicated on another drawing. Furthermore, in describing the exemplary embodiments of the present disclosure, detailed descriptions associated with well-known functions or configurations will be omitted if they may make subject matters of the present disclosure unnecessarily obscure.

In describing elements of an exemplary embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning which is consistent with their meaning in the context of the present disclosure and the relevant art and will not be interpreted in an idealized or overly formal sense unless so defined herein.

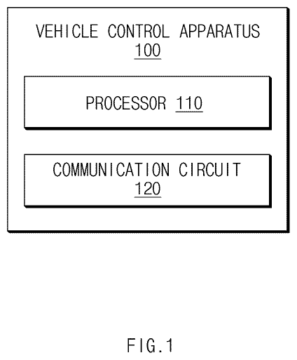

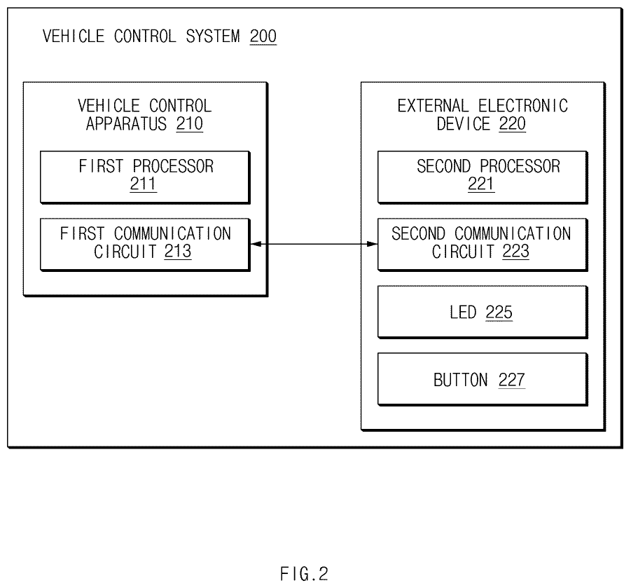

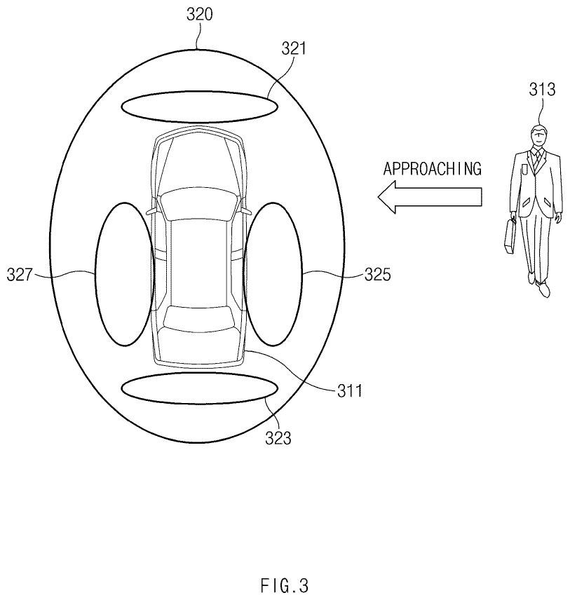

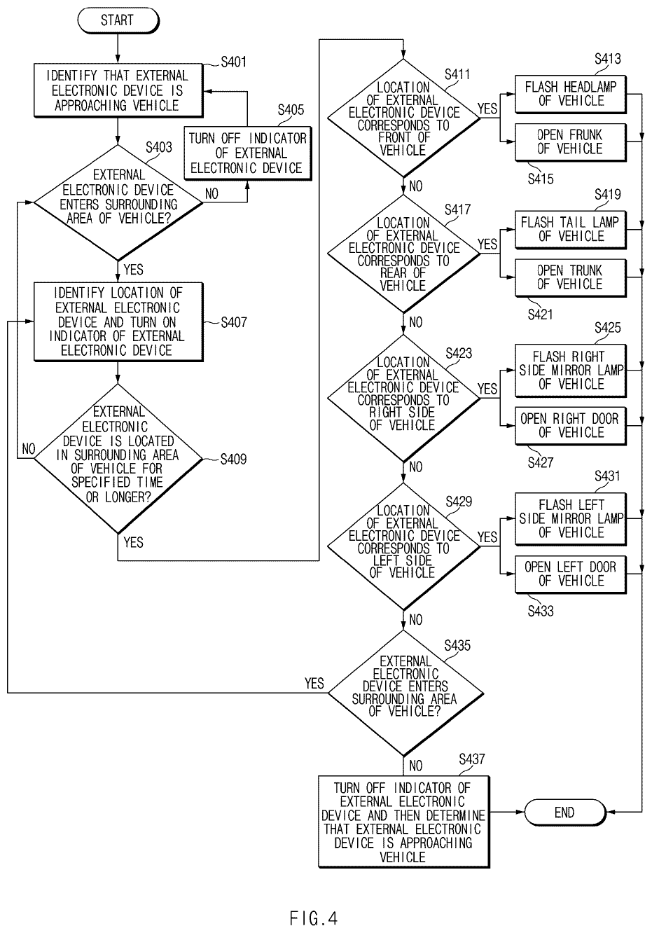

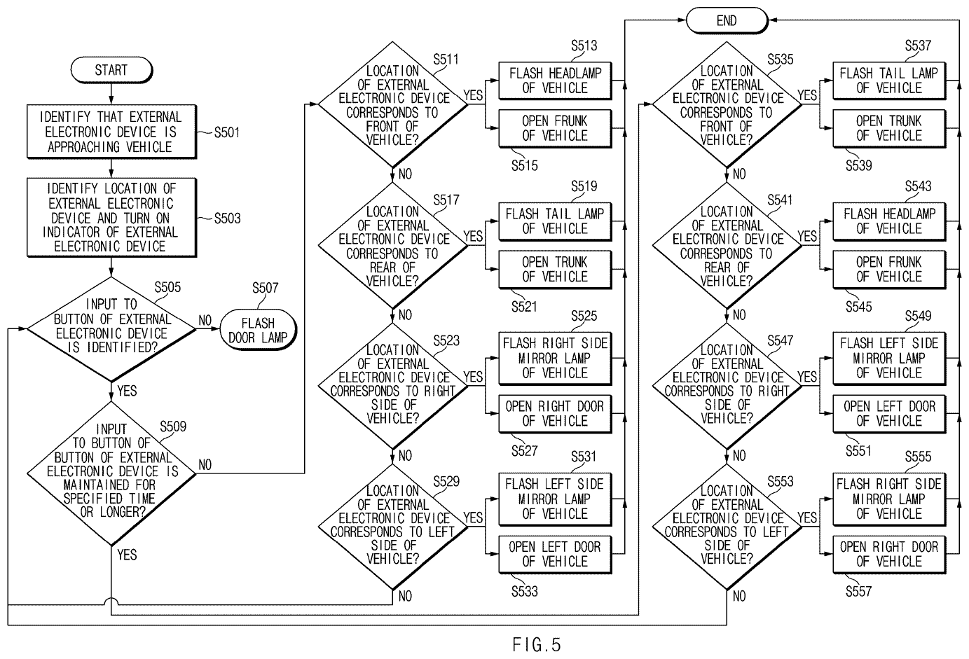

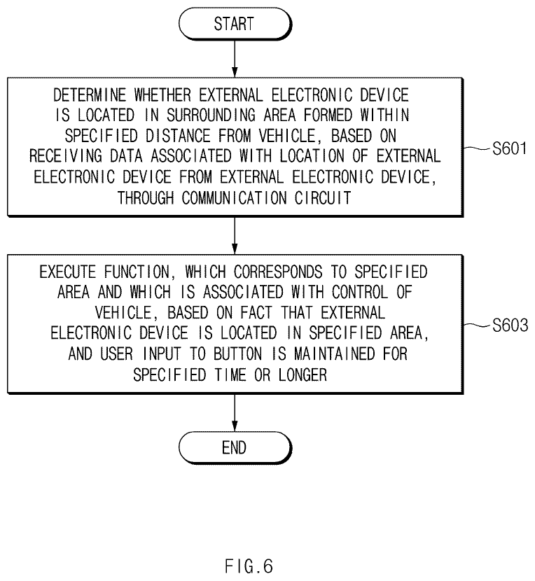

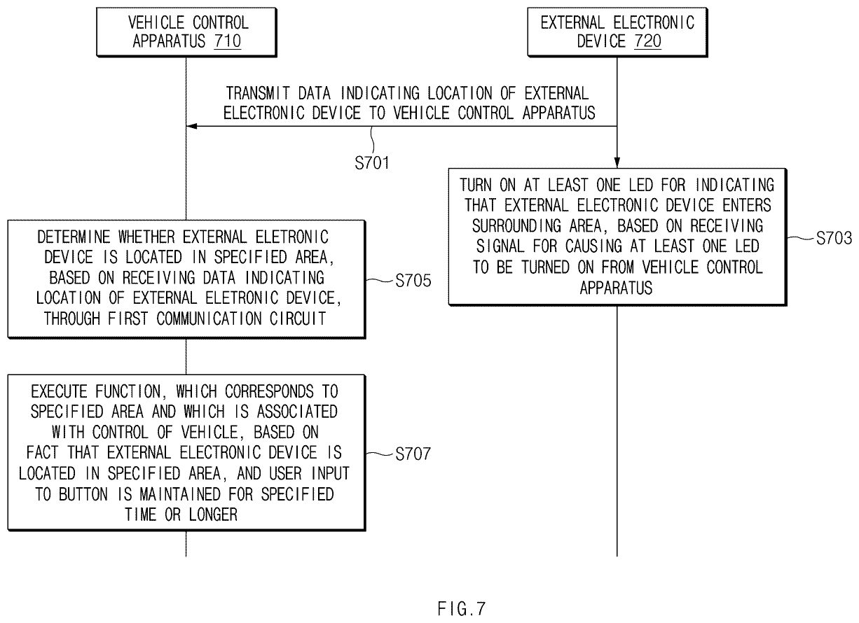

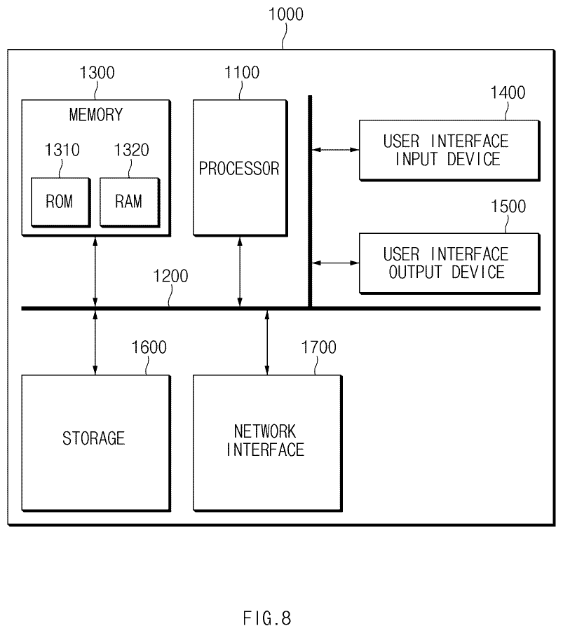

Hereinafter, various embodiments of the present disclosure will be described in detail with reference to FIG. 1, FIG. 2, FIG. 3, FIG. 4, FIG. 5, FIG. 6, FIG. 7, and FIG. 8.

FIG. 1 shows an example of a block diagram associated with a vehicle control apparatus, according to an exemplary embodiment of the present disclosure.

Referring to FIG. 1, a vehicle control apparatus 100 according to an exemplary embodiment of the present disclosure may be implemented inside or outside a vehicle, and some of components included in the vehicle control apparatus 100 may be implemented inside or outside the vehicle. At the instant time, the vehicle control apparatus 100 may be integrated with internal control units of a vehicle and may be implemented with a separate device to be coupled with control units of the vehicle by a separate connection means. For example, the vehicle control apparatus 100 may further include components not shown in FIG. 1.

A vehicle control apparatus 100 according to various exemplary embodiments of the present disclosure may include a processor 110 and a communication circuit 120. The processor 110 or the communication circuit 120 may be electrically and/or operably coupled with each other by an electronic component including a communication bus.

Hereinafter, the fact that pieces of hardware are coupled operably may include the fact that a direct and/or indirect connection between the pieces of hardware is established by wired and/or wirelessly so that second hardware is controlled by first hardware among the pieces of hardware.

Although different blocks are shown, an exemplary embodiment of the present disclosure is not limited thereto. Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to various exemplary embodiments of the present disclosure may include hardware for processing data based on one or more instructions. The hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or may include a structure of a multi-core processor including a dual core, a quad core, a hexa core, or an octa core.

The communication circuit 120 of the vehicle control apparatus 100 according to various exemplary embodiments of the present disclosure may include a hardware component for supporting transmission and/or reception of signals between the vehicle control apparatus 100 and an external electronic device. For example, the communication circuit 120 may include at least one of a MODEM, an antenna, or an optical/electronic (O/E) converter, or any combination thereof.

For example, the communication circuit 120 may support transmission and/or reception of signals based on various types of protocols including at least one of Ethernet, local area network (LAN), wide area network (WAN), wireless fidelity (WiFi), Bluetooth, Bluetooth low energy (BLE), ZigBee, Long Term Evolution (LTE), 5G new radio (NR), Controller Area Network (CAN), or Local Interconnect Network (LIN), or any combination thereof.

The processor 110 of the vehicle control apparatus 100 according to various exemplary embodiments of the present disclosure may receive data associated with a location of an external electronic device from the external electronic device through the communication circuit 120. For example, the external electronic device may include at least one of a smart key, or a key fob, or any combination thereof.

For example, the vehicle control apparatus 100 may include at least one of an integrated body unit (IBU), or a body domain controller (BDC), or any combination thereof.

For example, the processor 110 may be included in the external electronic device, and may receive data associated with a location of the external electronic device from an ultra-wide band (UWB) master and/or UWB slave, which utilizes a UWB frequency band.

According to an exemplary embodiment of the present disclosure, the processor 110 may be configured to determine whether the external electronic device is located in a surrounding area formed within a specified distance from the vehicle, based on receiving data associated with the location of the external electronic device from the external electronic device, through the communication circuit 120.

For example, the processor 110 may perform different operations depending on whether the external electronic device is located within a surrounding area formed within a specified distance from the vehicle. For example, the surrounding area formed within the specified distance may include at least one of a low frequency (LF) sensing area, or a radio frequency (RF) sensing area, or any combination thereof.

According to an exemplary embodiment of the present disclosure, the processor 110 may identify that an external electronic device is located in a specified area of the surrounding area. For example, the processor 110 may execute a function, which corresponds to a specified area and which is associated with the control of the vehicle, based on the external electronic device being located in a specified area of the surrounding area,

According to an exemplary embodiment of the present disclosure, the processor 110 may receive a signal, which is associated with a user input to the external electronic device, through the communication circuit 120. For example, the processor 110 may receive a signal indicating whether a user input to the external electronic device is maintained for a specified time or longer, through the communication circuit 120. For example, the specified time may include approximately 1.5 seconds. However, the specified time is not limited to that described above.

The following descriptions may be associated with operations performed based on the fact that a user input to a button included in the external electronic device is maintained for a specified time or longer than the specified time. Besides, the external electronic device may include a single button and may transmit a signal indicating a user input to the vehicle control apparatus 100, which is included in the vehicle, based on a user input to the single button.

For example, the processor 110 may cause headlamps of the vehicle to blink based on the external electronic device being located in a first specified area, which corresponds to the front of the vehicle, in the surrounding area.

For example, the processor 110 may execute a first function that causes a frunk of the vehicle to be opened, based on the external electronic device being located in the first specified area, which corresponds to the front of the vehicle, in the surrounding area. For example, the frunk may refer to a trunk located in the front of the vehicle.

For example, the first function may include an operation that causes headlamps of the vehicle to blink and causes the frunk of the vehicle to be opened.

For example, the processor 110 may cause a tail lamp of the vehicle to blink based on the external electronic device being located in a second specified area, which corresponds to the rear of the vehicle, in the surrounding area.

For example, the processor 110 may execute a second function that causes a trunk of the vehicle to be opened, based on the external electronic device being located in a second specified area, which corresponds to the rear of the vehicle, in the surrounding area.

For example, the second function may include an operation that causes a tail lamp of the vehicle to blink and causes trunk of the vehicle to be opened.

For example, the processor 110 may cause at least one of a right side mirror lamp included in a side mirror of the vehicle, or a lamp located on the right side surface of the vehicle, or any combination thereof to blink based on the external electronic device being located in a third specified area, which corresponds to the right side of the vehicle, in the surrounding area. The operation that causes a lamp included in the vehicle to blink is not limited to the above-described example. For example, the processor 110 may cause at least one lamp located on the right side surface of the vehicle to blink based on the external electronic device being located in the third specified area corresponding to the right side of the vehicle. For example, the at least one lamp may include at least one of an incandescent lamp, a fluorescent lamp, a three-wavelength lamp, a light emitting diode (LED), or a halogen lamp, or any combination thereof. However, the at least one lamp is not limited to that described above.

For example, the processor 110 may execute a third function that causes a right door of the vehicle to be opened based on the external electronic device being located in the third specified area, which corresponds to the right side of the vehicle, in the surrounding area.

For example, the third function may include an operation that causes at least one of a right side mirror lamp included in the side mirror of the vehicle, or a lamp located on the right side surface of the vehicle, or any combination thereof to blink, and causes the right door of the vehicle to be opened.

For example, the processor 110 may cause at least one of a left side mirror lamp included in the side mirror of the vehicle, or a lamp located on the left side surface of the vehicle, or any combination thereof to blink based on the external electronic device being located in a fourth specified area, which corresponds to the left side of the vehicle, in the surrounding area.

For example, the processor 110 may execute a fourth function that causes a left door of the vehicle to be opened based on the external electronic device being located in the fourth specified area, which corresponds to the left side of the vehicle, in the surrounding area.

For example, the fourth function may include an operation that causes at least one of a left side mirror lamp included in the side mirror of the vehicle, or a lamp located on the left side surface of the vehicle, or any combination thereof to blink, and causes the left door of the vehicle to be opened. The operation that causes a lamp included in the vehicle to blink is not limited to the above-described example. For example, the processor 110 may cause at least one lamp placed on the left side surface of the vehicle to blink based on the external electronic device being located in the fourth specified area corresponding to the left side of the vehicle. For example, the at least one lamp may include at least one of an incandescent lamp, a fluorescent lamp, a three-wavelength lamp, a light emitting diode (LED), or a halogen lamp, or any combination thereof. However, the at least one lamp is not limited to that described above.

As described above, the right door of the vehicle and/or the left door of the vehicle may include a power sliding door (PSD).

According to an exemplary embodiment of the present disclosure, the processor 110 may identify that the external electronic device is moving from the surrounding area to an area different from the surrounding area. For example, moving to an area different from the surrounding area may include moving from the surrounding area to the outside of the surrounding area. For example, the processor 110 may identify that the external electronic device is moving from the surrounding area to an area different from the surrounding area based on data indicating a location of the external electronic device.

According to an exemplary embodiment of the present disclosure, the processor 110 may cause at least one LED included in the external electronic device to blink based on identifying that the external electronic device is moving from the surrounding area to an area different from the surrounding area. For example, the processor 110 may transmit a signal for causing at least one LED included in the external electronic device to blink based on identifying that the external electronic device is moving from the surrounding area to an area different from the surrounding area.

According to an exemplary embodiment of the present disclosure, the processor 110 may cause at least one LED blinking at a first period to blink at a second period different from the first period, based on identifying that the external electronic device is moving from the surrounding area to an area different from the surrounding area. For example, the second period may be shorter than the first period.

Accordingly, as moving from the surrounding area to an area different from the surrounding area, the external electronic device may blink at the second period shorter than the first period to inform the user that a function associated with control of the vehicle is incapable of being executed.

As described above, it is described that the second period is shorter than the first period, but an exemplary embodiment of the present disclosure is not limited thereto. For example, according to an exemplary embodiment of the present disclosure, the second period may be longer than the first period.

According to an exemplary embodiment of the present disclosure, the processor 110 may cause at least one LED, which emits light in a first color and which is included in the external electronic device, to emit light in a second color different from the first color based on identifying that the external electronic device is moving from the surrounding area to an area different from the surrounding area.

For example, the at least one LED emitting light may include the fact that at least one LED blinks.

According to an exemplary embodiment of the present disclosure, the processor 110 may output a guide sound indicating that the external electronic device moves from a surrounding area to an area different from the surrounding area, through a speaker included in the vehicle based on identifying that the external electronic device is moving from the surrounding area to an area different from the surrounding area.

Hereinafter, an exemplary embodiment different from the exemplary embodiment described above will be described later.

According to an exemplary embodiment of the present disclosure, if a user input to a button included in the external electronic device is maintained for a specified time or longer, the processor 110 may cause a tail lamp of the vehicle to blink based on the external electronic device being located in the first specified area, which corresponds to the front of the vehicle, in the surrounding area.

Moreover, if a user input to a button included in the external electronic device is maintained for a specified time or longer, the processor 110 may execute the second function of causing the trunk of the vehicle to be opened, based on the external electronic device being located in the first specified area, which corresponds to the front of the vehicle, in the surrounding area.

According to an exemplary embodiment of the present disclosure, if a user input to a button included in the external electronic device is maintained for a specified time or longer, the processor 110 may cause a headlamp of the vehicle to blink based on the external electronic device being located in the first specified area.

Moreover, if a user input to a button included in the external electronic device is maintained for a specified time or longer, the processor 110 may execute a first function of causing the frunk of the vehicle to be opened, based on the external electronic device being located in the first specified area.

According to an exemplary embodiment of the present disclosure, if a user input to a button included in the external electronic device is maintained for a specified time or longer, the processor 110 may cause the headlamp of the vehicle to blink based on the external electronic device being located in the second specified area, which corresponds to the rear of the vehicle, in the surrounding area.

Moreover, if a user input to a button included in the external electronic device is maintained for a specified time or longer, the processor 110 may execute the first function of causing the frunk of the vehicle to be opened, based on the external electronic device being located in the second specified area.

According to an exemplary embodiment of the present disclosure, if a user input to a button included in the external electronic device is maintained for a specified time or longer, the processor 110 may cause the tail lamp of the vehicle to blink based on the external electronic device being located in the second specified area, which corresponds to the rear of the vehicle, in the surrounding area.

Moreover, if a user input to a button included in the external electronic device is maintained for a specified time or longer, the processor 110 may execute the second function of causing the trunk of the vehicle to be opened, based on the external electronic device being located in the second specified area.

According to an exemplary embodiment of the present disclosure, if a user input to a button included in the external electronic device is maintained for a specified time or longer, the processor 110 may cause at least one of a left side mirror lamp included in the side mirror of the vehicle, or a lamp located on the left side surface of the vehicle, or any combination thereof to blink based on the external electronic device being located in the third specified area, which corresponds to the right side of the vehicle, in the surrounding area.

Moreover, if a user input to a button included in the external electronic device is maintained for a specified time or longer, the processor 110 may execute the fourth function of causing the left door of the vehicle to be opened, based on the external electronic device being located in the third specified area, which corresponds to the right side of the vehicle, in the surrounding area.

According to an exemplary embodiment of the present disclosure, if a user input to a button included in the external electronic device is maintained for a specified time or longer, the processor 110 may cause at least one of a right side mirror lamp included in the side mirror of the vehicle, or a lamp located on the right side surface of the vehicle, or any combination thereof to blink based on the external electronic device being located in the third specified area.

Moreover, if a user input to a button included in the external electronic device is maintained for a specified time or longer, the processor 110 may execute the third function of causing the right door of the vehicle to be opened, based on the external electronic device being located in the third specified area.

According to an exemplary embodiment of the present disclosure, if a user input to a button included in the external electronic device is maintained for a specified time or longer, the processor 110 may cause at least one of a right side mirror lamp included in the side mirror of the vehicle, or a lamp located on the right side surface of the vehicle, or any combination thereof to blink based on the external electronic device being located in the fourth specified area, which corresponds to the left side of the vehicle, in the surrounding area.

Moreover, if a user input to a button included in the external electronic device is maintained for a specified time or longer, the processor 110 may execute the third function of causing the right door of the vehicle to be opened, based on the external electronic device being located in the fourth specified area.

According to an exemplary embodiment of the present disclosure, if a user input to a button included in the external electronic device is maintained for a specified time or longer, the processor 110 may cause at least one of a left side mirror lamp included in the side mirror of the vehicle, or a lamp located on the left side surface of the vehicle, or any combination thereof to blink based on the external electronic device being located in the fourth specified area corresponding to the left side of the vehicle.

Moreover, if a user input to a button included in the external electronic device is maintained for a specified time or longer, the processor 110 may execute the fourth function of causing the left door of the vehicle to be opened, based on the external electronic device being located in the fourth specified area.

As described above, the processor 110 of the vehicle control apparatus 100 according to various exemplary embodiments of the present disclosure may perform different operations or may execute different functions depending on the location of the external electronic device with respect to the vehicle. The processor 110 may execute different functions depending on the location of the external electronic device with respect to the vehicle, improving user convenience.

FIG. 2 shows an example of a block diagram associated with a vehicle control system, according to an exemplary embodiment of the present disclosure.

Referring to FIG. 2, a vehicle control system 200 may include a vehicle control apparatus 210 and an external electronic device 220.

According to an exemplary embodiment of the present disclosure, the vehicle control apparatus 210 may include a first processor 211 and a first communication circuit 213. For example, the first processor 211 may include the processor 110 of FIG. 1. For example, the first communication circuit 213 may include the communication circuit 120 of FIG. 1. For example, the vehicle control apparatus 210 may be included in the vehicle.

For example, the first communication circuit 213 may include hardware components for establishing a communication link with the external electronic device 220.

According to an exemplary embodiment of the present disclosure, the external electronic device 220 may include a second processor 221, a second communication circuit 223, an LED 225, and a button 227. For example, the second processor 221 may include the processor 110 of FIG. 1. For example, the second communication circuit 223 may include the communication circuit 120 of FIG. 1.

For example, the second communication circuit 223 may include hardware components for establishing a communication link with the vehicle control apparatus 210.

For example, the external electronic device 220 may include at least one of a smart key, or a key fob, or any combination thereof.

According to an exemplary embodiment of the present disclosure, the LED 225 included in the external electronic device 220 may be referred to as an indicator.

According to an exemplary embodiment of the present disclosure, the button 227 included in the external electronic device 220 may include at least one of a pressure-sensitive button for identifying an input based on pressure, or a touch-type button for identifying an input based on a touch input, or any combination thereof.

For example, the touch-type button may include at least one of a capacitive button, a pressure-sensitive button, or an optical button, or any combination thereof.

According to an exemplary embodiment of the present disclosure, the second processor 221 of the external electronic device 220 may transmit data indicating the location of the external electronic device 220 to the vehicle control apparatus 210 through the second communication circuit 223.

For example, the second processor 221 of the external electronic device 220 may transmit data indicating the location of the external electronic device 220 to the vehicle control apparatus 210 by use of a UWB master/slave.

According to an exemplary embodiment of the present disclosure, the second processor 221 may receive a signal for causing the at least one LED 225 to be turned on from the vehicle control apparatus 210. For example, the second processor 221 may turn on the at least one LED 225 for indicating that an external electronic device enters a surrounding area formed within a specified distance from a vehicle, based on receiving the signal for causing the at least one LED 225 to be turned on from the vehicle control apparatus 210. For example, the specified distance may include approximately 5 m. However, the specified distance is not limited to that described above.

Furthermore, a point in time at which a signal for causing the at least one LED 225 to be turned on is received from the vehicle control apparatus 210 is not limited thereto.

According to an exemplary embodiment of the present disclosure, the first processor 211 may execute a function, which corresponds to a specified area and which is associated with control of the vehicle, based on the external electronic device 220 being located in a specified area of the surrounding area, and data indicating a location of the external electronic device 220 through the first communication circuit 213.

For example, the specified area of the surrounding area may include a first specified area corresponding to the front of the vehicle. For example, the specified area of the surrounding area may include a second specified area corresponding to the rear of the vehicle. For example, the specified area of the surrounding area may include a third specified area corresponding to the right side of the vehicle. For example, the specified area of the surrounding area may include a fourth specified area corresponding to the left side of the vehicle.

In summary, the specified area of the surrounding area may include the first specified area corresponding to the front of the vehicle, the second specified area corresponding to the rear of the vehicle, the third specified area corresponding to the right side of the vehicle, and the fourth specified area corresponding to the left side of vehicle.

For example, the vehicle control apparatus 210 may execute a function corresponding to each area among the first to fourth functions described in FIG. 1 based on the external electronic device being identified in one of the specified areas.

For example, the function associated with control of the vehicle may include the first function that causes a headlamp of the vehicle to be turned on and causes a frunk of the vehicle to be opened. For example, the function associated with control of the vehicle may include the second function that causes a tail lamp of the vehicle to be turned on and causes a trunk of the vehicle to be opened. For example, the function associated with control of the vehicle may include the third that causes at least one of a right side mirror lamp included in the side mirror of the vehicle, or a lamp located on the right side surface of the vehicle, or any combination thereof to be turned on, and causes a right door of the vehicle to be opened. For example, the function associated with control of the vehicle may include the fourth that causes at least one of a left side mirror lamp included in the side mirror of the vehicle, or a lamp located on the left side surface of the vehicle, or any combination thereof to be turned on, and causes a left door of the vehicle to be opened.

According to an exemplary embodiment of the present disclosure, the second processor 221 of the external electronic device 220 may transmit a signal associated with a user input to the button 227 to the vehicle control apparatus 210 through the second communication circuit 223.

According to an exemplary embodiment of the present disclosure, the first processor 211 of the vehicle control apparatus 210 may receive the signal associated with the user input to the button 227 from the external electronic device 220 through the first communication circuit 213. For example, the first processor 211 may be configured to determine whether a user input to the button 227 is maintained for a specified time or longer than the specified time.

For example, the first processor 211 may execute the function associated with control of the vehicle at a location corresponding to a point in time at which the user input is performed, based on the user input to the button 227 being maintained for the specified time or longer than the specified time.

For example, the first processor 211 may execute the function associated with control of the vehicle at a location opposite to the location, which corresponds to the point in time at which the user input is performed based on the vehicle, based on the user input to the button 227 being maintained for the specified time or longer than the specified time.

For example, if the user input to the button 227 in the first specified area is maintained for the specified time or longer, the first processor 211 may execute the function associated with control of the vehicle in the first specified area, which is a location corresponding to the point in time at which the user input is performed.

For example, if the user input to the button 227 in the second specified area is maintained for the specified time or longer, the first processor 211 may execute the function associated with control of the vehicle in the second specified area, which is a location corresponding to the point in time at which the user input is performed.

For example, if the user input to the button 227 in the third specified area is maintained for the specified time or longer, the first processor 211 may execute the function associated with control of the vehicle in the third specified area, which is a location corresponding to the point in time at which the user input is performed.

For example, if the user input to the button 227 in the fourth specified area is maintained for the specified time or longer, the first processor 211 may execute the function associated with control of the vehicle in the fourth specified area, which is a location corresponding to the point in time at which the user input is performed.

The first function to fourth function described above may include functions performed on the front, rear, right side, and left side of the vehicle, respectively.

For example, if the user input to the button 227 in the first specified area is maintained for the specified time or longer, the first processor 211 may execute the function associated with control of the vehicle in the second specified area, which is a location in the opposite direction of the first specified area being the location corresponding to the point in time at which the user input is performed based on the vehicle.

For example, if the user input to the button 227 in the second specified area is maintained for the specified time or longer, the first processor 211 may execute the function associated with control of the vehicle in the first specified area, which is a location in the opposite direction of the second specified area being the location corresponding to the point in time at which the user input is performed based on the vehicle.

For example, if the user input to the button 227 in the third specified area is maintained for the specified time or longer, the first processor 211 may execute the function associated with control of the vehicle in the fourth specified area, which is a location in the opposite direction of the third specified area being the location corresponding to the point in time at which the user input is performed based on the vehicle.

For example, if the user input to the button 227 in the fourth specified area is maintained for the specified time or longer, the first processor 211 may execute the function associated with control of the vehicle in the third specified area, which is a location in the opposite direction of the fourth specified area being the location corresponding to the point in time at which the user input is performed based on the vehicle.

As described above, the vehicle control system 200 according to various exemplary embodiments of the present disclosure may execute different functions depending on the location of the external electronic device 220 with respect to the vehicle including the vehicle control apparatus 210. The vehicle control system 200 may execute different functions depending on the location of the external electronic device 220 with respect to the vehicle including the vehicle control apparatus 210, enhancing user experience.

FIG. 3 shows an example of a surrounding area of a vehicle, and a specified area of the surrounding area, according to an exemplary embodiment of the present disclosure.

Referring to FIG. 3, a processor (e.g., the processor 110 in FIG. 1 and/or the first processor 211 in FIG. 2) of a vehicle control apparatus (e.g., the vehicle control apparatus 100 of FIG. 1 and/or the vehicle control apparatus 210 of FIG. 2) according to various exemplary embodiments of the present disclosure may identify that a user 313 is approaching a vehicle 311. In FIG. 3, the user 313 may include a user who owns an external electronic device (e.g., the external electronic device 220 in FIG. 2) including at least one of a smart key, or a key fob, or any combination thereof.

For example, the processor of the vehicle control apparatus may identify that the user 313 is approaching a surrounding area 320 of the vehicle 311. For example, the surrounding area 320 may include a remote smart parking assist (RSPA) area. For example, the surrounding area 320 may be an area included within a radius of about 5 m from the vehicle 311. For example, the surrounding area 320 may be an area included in a radius within a specified distance from the center of gravity of the vehicle 311.

For example, the surrounding area 320 may include a first specified area 321, a second specified area 323, a third specified area 325, and a fourth specified area 327. For example, the first specified area 321 may include an area corresponding to the front of the vehicle. For example, the second specified area 323 may include an area corresponding to the rear of the vehicle. For example, the third specified area 325 may include an area corresponding to the right side of the vehicle. For example, the fourth specified area 327 may include an area corresponding to the left side of the vehicle.

In FIG. 3, the first specified area 321, the second specified area 323, the third specified area 325, and the fourth specified area 327 are shown in oval shapes, but an exemplary embodiment of the present disclosure is not limited thereto.

For example, the first specified area 321 may include an area formed as an oval corresponding to the front of the vehicle, or an area formed as a polygon including a rectangle. For example, the second specified area 323 may include an area formed as an oval corresponding to the rear of the vehicle, or an area formed as a polygon including a rectangle. For example, the third specified area 325 may include an area formed as an oval corresponding to the right side of the vehicle, or an area formed as a polygon including a rectangle. For example, the fourth specified area 327 may include an area formed as an oval corresponding to the left side of the vehicle, or an area formed as a polygon including a rectangle.

According to an exemplary embodiment of the present disclosure, as the user 313 who owns an external electronic device approaches the vehicle 311, the processor may execute a function corresponding to each area based on the user 313 being located in one of the specified areas 321, 323, 325, and 327. For example, the function corresponding to each area may include the first to fourth functions described in FIG. 1 and FIG. 2.

FIG. 4 shows an example of a flowchart associated with a vehicle control method, according to an exemplary embodiment of the present disclosure.

At least one of operations of FIG. 4 may be performed by the vehicle control apparatus 100 of FIG. 1, the vehicle control apparatus 210 of FIG. 2, and/or the external electronic device 220 of FIG. 2. Each of the operations in FIG. 4 may be performed sequentially, but is not necessarily sequentially performed. For example, the order of operations may be changed, and at least two operations may be performed in parallel.

Hereinafter, it is assumed that the vehicle control apparatus 100 of FIG. 1, the vehicle control apparatus 210 of FIG. 2, and/or the external electronic device 220 of FIG. 2 perform the process of FIG. 4. Furthermore, in a description of FIG. 4, it may be understood that an operation referred to as being performed by an apparatus is controlled by the processor 110 of the vehicle control apparatus 100, the first processor 211, and/or the external electronic device 220 of the second processor 221.

Referring to FIG. 4, in S401, a vehicle control method according to various exemplary embodiments of the present disclosure may include an operation of identifying that an external electronic device (e.g., the external electronic device 220 in FIG. 2) is approaching the vehicle (e.g., the vehicle 311 in FIG. 3).

For example, the vehicle control method may include an operation of identify that an external electronic device is approaching the vehicle based on a UWB signal transmitted from the external electronic device.

In S403, the vehicle control method according to various exemplary embodiments of the present disclosure may include an operation of determining whether the external electronic device enters a surrounding area (e.g., the surrounding area 320 in FIG. 3) of the vehicle.

For example, the vehicle control method may include an operation of determining whether the external electronic device enters the surrounding area of the vehicle, based on the UWB signal transmitted from the external electronic device.

If the external electronic device does not enter the surrounding area of the vehicle (No in S403), in S405, the vehicle control method according to various exemplary embodiments of the present disclosure may include an operation of turning off an indicator of the external electronic device. For example, the vehicle control method may include an operation of turning off the indicator of the external electronic device based on transmitting a signal to the external electronic device that causes the indicator to be turned off. For example, the indicator may include at least one LED included in the external electronic device.

If the external electronic device enters the surrounding area of the vehicle (Yes in S403), in S407, the vehicle control method according to various exemplary embodiments of the present disclosure may include an operation of identifying a location of the external electronic device and turning on the indicator of the external electronic device.

For example, the location of the external electronic device may include a relative location of the external electronic device relative to the vehicle.

In S409, the vehicle control method according to various exemplary embodiments of the present disclosure may include an operation of determining whether the external electronic device is located in the surrounding area of the vehicle for a specified time or longer than the specified time.

For example, the vehicle control method may include an operation of determining whether the external electronic device is located in a specified area (e.g., the first specified area 321, the second specified area 323, the third specified area 325, and/or the fourth specified area 327 of FIG. 3) of the surrounding area of the vehicle for the specified time or longer than the specified time. For example, the specified time may include approximately 3 seconds.

If the external electronic device is not located in the surrounding area of the vehicle for the specified time or longer (No in S409), the vehicle control method according to various exemplary embodiments of the present disclosure may include an operation of returning to S403 and then determining whether the external electronic device enters the surrounding area of the vehicle.

If the external electronic device is located in the surrounding area of the vehicle for the specified time or longer (Yes in S409), in S411, the vehicle control method according to various exemplary embodiments of the present disclosure may include an operation of determining whether the location of the external electronic device corresponds to the front of the vehicle. For example, the operation of determining whether the location of the external electronic device corresponds to the front of the vehicle may include an operation of determining whether the location of the external electronic device is a first specified area.

If the location of the external electronic device corresponds to the front of the vehicle (Yes in S411), in S413, the vehicle control method according to various exemplary embodiments of the present disclosure may include an operation of flashing a headlamp of the vehicle.

If the location of the external electronic device corresponds to the front of the vehicle (Yes in S411), in S415, the vehicle control method according to various exemplary embodiments of the present disclosure may include an operation of opening a frunk of the vehicle.

S413 and S415 described above may be performed sequentially, or in parallel and substantially simultaneously.

If the location of the external electronic device does not correspond to the front of the vehicle (No in S411), in S417, the vehicle control method according to various exemplary embodiments of the present disclosure may include an operation of determining whether the location of the external electronic device corresponds to the rear of the vehicle. For example, the operation of determining whether the location of the external electronic device corresponds to the rear of the vehicle may include an operation of determining whether the location of the external electronic device is a second specified area.

If the location of the external electronic device corresponds to the rear of the vehicle (Yes in S417), in S419, the vehicle control method according to various exemplary embodiments of the present disclosure may include an operation of flashing a tail lamp of the vehicle.

If the location of the external electronic device corresponds to the rear of the vehicle (Yes in S417), in S421, the vehicle control method according to various exemplary embodiments of the present disclosure may include an operation of opening a trunk of the vehicle.

S419 and S421 described above may be performed sequentially, or in parallel and substantially simultaneously.

If the location of the external electronic device does not correspond to the rear of the vehicle (No in S417), in S423, the vehicle control method according to various exemplary embodiments of the present disclosure may include an operation of determining whether the location of the external electronic device corresponds to the right side of the vehicle. For example, the operation of determining whether the location of the external electronic device corresponds to the right side of the vehicle may include an operation of determining whether the location of the external electronic device is a third specified area.

If the location of the external electronic device corresponds to the right side of the vehicle (Yes in S423), in S425, the vehicle control method according to various exemplary embodiments of the present disclosure may include an operation of flashing a right side mirror lamp of the vehicle. For example, the vehicle control method may include an operation of flashing at least one lamp located on the right side surface of the vehicle.

If the location of the external electronic device corresponds to the right side of the vehicle (Yes in S423), in S427, the vehicle control method according to various exemplary embodiments of the present disclosure may include an operation of opening a right door of the vehicle.

S425 and S427 described above may be performed sequentially, or in parallel and substantially simultaneously.

If the location of the external electronic device does not correspond to the right side of the vehicle (No in S423), in S429, the vehicle control method according to various exemplary embodiments of the present disclosure may include an operation of determining whether the location of the external electronic device corresponds to the left side of the vehicle. For example, the operation of determining whether the location of the external electronic device corresponds to the left side of the vehicle may include an operation of determining whether the location of the external electronic device is a fourth specified area.

If the location of the external electronic device corresponds to the left side of the vehicle (Yes in S429), in S431, the vehicle control method according to various exemplary embodiments of the present disclosure may include an operation of flashing a left side mirror lamp of the vehicle. For example, the vehicle control method may include an operation of flashing at least one lamp located on the left side surface of the vehicle.

If the location of the external electronic device corresponds to the left side of the vehicle (Yes in S429), in S433, the vehicle control method according to various exemplary embodiments of the present disclosure may include an operation of opening a left door of the vehicle.

S431 and S433 described above may be performed sequentially, or in parallel and substantially simultaneously.

If the location of the external electronic device does not correspond to the left side of the vehicle (No in S429), in S435, the vehicle control method according to various exemplary embodiments of the present disclosure may include an operation of determining whether the external electronic device enters the surrounding area of the vehicle. For example, S435 may include substantially the same operation as S403.

If the external electronic device enters the surrounding area of the vehicle (Yes in S435), the vehicle control method according to various exemplary embodiments of the present disclosure may include an operation of returning to S407, identifying the location of the external electronic device, and turning on the indicator of the external electronic device.

If the external electronic device does not enter the surrounding area of the vehicle (No in S435), in S437, the vehicle control method according to various exemplary embodiments of the present disclosure may include an operation of turning off the indicator of the external electronic device and then determining whether the external electronic device is approaching the vehicle.

As described above, the vehicle control method according to various exemplary embodiments of the present disclosure may perform different functions depending on the location of the external electronic device. The vehicle control method may perform different functions depending on the location of the external electronic device, enhancing user experience.

FIG. 5 shows an example of a flowchart associated with a vehicle control method, according to an exemplary embodiment of the present disclosure.

At least one of operations of FIG. 5 may be performed by the vehicle control apparatus 100 of FIG. 1, the vehicle control apparatus 210 of FIG. 2, and/or the external electronic device 220 of FIG. 2. Each of the operations in FIG. 5 may be performed sequentially, but is not necessarily sequentially performed. For example, the order of operations may be changed, and at least two operations may be performed in parallel.

Hereinafter, it is assumed that the vehicle control apparatus 100 of FIG. 1, the vehicle control apparatus 210 of FIG. 2, and/or the external electronic device 220 of FIG. 2 perform the process of FIG. 5. Furthermore, in a description of FIG. 5, it may be understood that an operation referred to as being performed by an apparatus is controlled by the processor 110 of the vehicle control apparatus 100, the first processor 211, and/or the external electronic device 220 of the second processor 221.

Referring to FIG. 5, in S501, a vehicle control method according to various exemplary embodiments of the present disclosure may include an operation of identifying that an external electronic device (e.g., the external electronic device 220 in FIG. 2) is approaching a vehicle.

For example, the vehicle control method may include an operation of identifying a location of the external electronic device based on a UWB signal transmitted from the external electronic device. For example, the vehicle control method may receive data associated with the location of the external electronic device transmitted from the external electronic device, and may identify that the external electronic device is approaching the vehicle, based on the received data. For example, the data associated with the location of an external electronic device may be included in the UWB signal. For example, the data associated with the location of the external electronic device may be transmitted to the vehicle control apparatus at a specified period to indicate the location of the external electronic device.

For example, the vehicle control method may include an operation of identifying an external electronic device approaching within the surrounding area of the vehicle.

In S503, the vehicle control method according to various exemplary embodiments of the present disclosure may include an operation of identifying a location of the external electronic device and turning on an indicator of the external electronic device.

For example, the operation of identifying the location of the external electronic device may include an operation of determining whether the external electronic device is located in a specified area of the surrounding area of the vehicle.

For example, the indicator of the external electronic device may be performed by a processor (e.g., the second processor 221 in FIG. 2) included in the external electronic device.

In S505, the vehicle control method according to various exemplary embodiments of the present disclosure may include an operation of determining whether there is an input to a button of the external electronic device. For example, the vehicle control method may include an operation of receiving data (or a signal) associated with a user input to the button included in the external electronic device, from the external electronic device. The vehicle control method may include an operation of determining whether there is an input to the button of the external electronic device, based on receiving data associated with the user input to the button included in the external electronic device.

If the input to the button of the external electronic device is not identified (No in S505), in S507, the vehicle control method according to various exemplary embodiments of the present disclosure may include an operation of flashing a door lamp included in the vehicle.

For example, if the input to the button of the external electronic device is not identified, the vehicle control method may include an operation of flashing at least one lamp located on at least one of a left side surface, or a right side surface, or any combination of the vehicle.

If the input to the button of the external electronic device is identified (Yes in S505), in S509, the vehicle control method according to various exemplary embodiments of the present disclosure may include an operation of determining whether an input to the button of the external electronic device is maintained for a specified time or longer than the specified time.

If the input to the button of the external electronic device is not maintained for the specified time or longer (No in S509), in S511, the vehicle control method according to various exemplary embodiments of the present disclosure may include an operation of determining whether the location of the external electronic device corresponds to the front of the vehicle. S511 of FIG. 5 may include S411 of FIG. 4.

If the location of the external electronic device corresponds to the front of the vehicle (Yes in S511), in S513, the vehicle control method according to various exemplary embodiments of the present disclosure may include an operation of flashing a headlamp of the vehicle. S513 of FIG. 5 may include S413 of FIG. 4.

If the location of the external electronic device corresponds to the front of the vehicle (Yes in S511), in S515, the vehicle control method according to various exemplary embodiments of the present disclosure may include an operation of opening a frunk of the vehicle. S515 of FIG. 5 may include S415 of FIG. 4.

S513 and S515 described above may be performed sequentially, or in parallel and substantially simultaneously.

If the location of the external electronic device does not correspond to the front of the vehicle (No in S511), in S517, the vehicle control method according to various exemplary embodiments of the present disclosure may include an operation of determining whether the location of the external electronic device corresponds to the rear of the vehicle. S517 of FIG. 5 may include S417 of FIG. 4.

If the location of the external electronic device corresponds to the rear of the vehicle (Yes in S517), in S519, the vehicle control method according to various exemplary embodiments of the present disclosure may include an operation of flashing a tail lamp of the vehicle. S519 of FIG. 5 may include S419 of FIG. 4.

If the location of the external electronic device corresponds to the rear of the vehicle (Yes in S517), in S521, the vehicle control method according to various exemplary embodiments of the present disclosure may include an operation of opening a trunk of the vehicle. S521 of FIG. 5 may include S421 of FIG. 4.

S519 and S521 described above may be performed sequentially, or in parallel and substantially simultaneously.

If the location of the external electronic device does not correspond to the rear of the vehicle (No in S517), in S523, the vehicle control method according to various exemplary embodiments of the present disclosure may include an operation of determining whether the location of the external electronic device corresponds to the right side of the vehicle. S523 of FIG. 5 may include S423 of FIG. 4.

If the location of the external electronic device corresponds to the right side of the vehicle (Yes in S523), in S525, the vehicle control method according to various exemplary embodiments of the present disclosure may include an operation of flashing a right side mirror lamp of the vehicle. S525 of FIG. 5 may include S425 of FIG. 4.

If the location of the external electronic device corresponds to the right side of the vehicle (Yes in S523), in S527, the vehicle control method according to various exemplary embodiments of the present disclosure may include an operation of opening a right door of the vehicle. S527 of FIG. 5 may include S427 of FIG. 4.

S525 and S527 described above may be performed sequentially, or in parallel and substantially simultaneously.

If the location of the external electronic device does not correspond to the right side of the vehicle (No in S523), in S529, the vehicle control method according to various exemplary embodiments of the present disclosure may include an operation of determining whether the location of the external electronic device corresponds to the left side of the vehicle. S529 of FIG. 5 may include S429 of FIG. 4.

If the location of the external electronic device corresponds to the left side of the vehicle (Yes in S529), in S531, the vehicle control method according to various exemplary embodiments of the present disclosure may include an operation of flashing a left side mirror lamp of the vehicle. S531 of FIG. 5 may include S431 of FIG. 4.

If the location of the external electronic device corresponds to the left side of the vehicle (Yes in S529), in S533, the vehicle control method according to various exemplary embodiments of the present disclosure may include an operation of opening a left door of the vehicle. S533 of FIG. 5 may include S433 of FIG. 4.

S531 and S533 described above may be performed sequentially, or in parallel and substantially simultaneously.

If the input to the button of the external electronic device is maintained for the specified time or longer (Yes in S509), in S535, the vehicle control method according to various exemplary embodiments of the present disclosure may include an operation of determining whether the location of the external electronic device corresponds to the front of the vehicle. For example, S535 of FIG. 5 may include S511 and/or S411 of FIG. 4.

If the location of the external electronic device corresponds to the front of the vehicle (Yes in S535), in S537, the vehicle control method according to various exemplary embodiments of the present disclosure may include an operation of flashing a tail lamp of the vehicle. For example, S535 of FIG. 5 may include S519 and/or S419 of FIG. 4.

If the location of the external electronic device corresponds to the front of the vehicle (Yes in S535), in S539, the vehicle control method according to various exemplary embodiments of the present disclosure may include an operation of opening a trunk of the vehicle. For example, S539 of FIG. 5 may include S521 and/or S421 of FIG. 4.

S537 and S539 described above may be performed sequentially, or in parallel and substantially simultaneously.

If the location of the external electronic device does not correspond to the front of the vehicle (No in S535), in S541, the vehicle control method according to various exemplary embodiments of the present disclosure may include an operation of determining whether the location of the external electronic device corresponds to the rear of the vehicle. For example, S541 of FIG. 5 may include S517 and/or S417 of FIG. 4.

If the location of the external electronic device corresponds to the rear of the vehicle (Yes in S541), in S543, the vehicle control method according to various exemplary embodiments of the present disclosure may include an operation of flashing a headlamp of the vehicle. For example, S543 of FIG. 5 may include S513 and/or S413 of FIG. 4.

If the location of the external electronic device corresponds to the rear of the vehicle (Yes in S541), in S545, the vehicle control method according to various exemplary embodiments of the present disclosure may include an operation of opening the frunk of the vehicle. For example, S545 of FIG. 5 may include S515 and/or S415 of FIG. 4.

S543 and S545 described above may be performed sequentially, or in parallel and substantially simultaneously.

If the location of the external electronic device does not correspond to the rear of the vehicle (No in S541), in S547, the vehicle control method according to various exemplary embodiments of the present disclosure may include an operation of determining whether the location of the external electronic device corresponds to the right side of the vehicle. For example, S547 of FIG. 5 may include S523 and/or S423 of FIG. 4.

If the location of the external electronic device corresponds to the right side of the vehicle (Yes in S547), in S549, the vehicle control method according to various exemplary embodiments of the present disclosure may include an operation of flashing a left side mirror lamp of the vehicle. For example, S549 of FIG. 5 may include S531 and/or S431 of FIG. 4.

If the location of the external electronic device corresponds to the right side of the vehicle (Yes in S547), in S551, the vehicle control method according to various exemplary embodiments of the present disclosure may include an operation of opening a left door of the vehicle. For example, S551 of FIG. 5 may include S533 and/or S433 of FIG. 4.

S549 and S551 described above may be performed sequentially, or in parallel and substantially simultaneously.

If the location of the external electronic device does not correspond to the right side of the vehicle (No in S547), in S553, the vehicle control method according to various exemplary embodiments of the present disclosure may include an operation of determining whether the location of the external electronic device corresponds to the left side of the vehicle. For example, S553 of FIG. 5 may include S529 and/or S429 of FIG. 4.

If the location of the external electronic device corresponds to the left side of the vehicle (Yes in S553), in S555, the vehicle control method according to various exemplary embodiments of the present disclosure may include an operation of flashing a right side mirror lamp of the vehicle. For example, S555 of FIG. 5 may include S525 and/or S425 of FIG. 4.

If the location of the external electronic device corresponds to the left side of the vehicle (Yes in S553), in S557, the vehicle control method according to various exemplary embodiments of the present disclosure may include an operation of opening a right door of the vehicle. For example, S557 of FIG. 5 may include S527 and/or S427 of FIG. 4.

S555 and S557 described above may be performed sequentially, or in parallel and substantially simultaneously.

As described above, the vehicle control method according to various exemplary embodiments of the present disclosure may perform different functions depending on the location of the external electronic device. The vehicle control method may perform different functions depending on the location of the external electronic device, improving user convenience of the vehicle control apparatus and/or the external electronic device.

FIG. 6 shows an example of a flowchart associated with a vehicle control method, according to an exemplary embodiment of the present disclosure.

At least one of operations of FIG. 6 may be performed by the vehicle control apparatus 100 of FIG. 1 and/or the vehicle control apparatus 210 of FIG. 2. Each of the operations in FIG. 6 may be performed sequentially, but is not necessarily sequentially performed. For example, the order of operations may be changed, and at least two operations may be performed in parallel.

Hereinafter, it is assumed that the vehicle control apparatus 100 of FIG. 1 and/or the vehicle control apparatus 210 of FIG. 2 perform the process of FIG. 6. Furthermore, in a description of FIG. 6, it may be understood that an operation referred to as being performed by an apparatus is controlled by the vehicle control apparatus 100 of the processor 110, and/or the first processor 211.

Referring to FIG. 6, in S601, a vehicle control method according to various exemplary embodiments of the present disclosure may include an operation of determining whether an external electronic device is located in a surrounding area formed within a specified distance from a vehicle, based on receiving data associated with a location of the external electronic device from the external electronic device, through a communication circuit.

In S603, the vehicle control method according to various exemplary embodiments of the present disclosure may include an operation of executing a function, which corresponds to the specified area and which is associated with control of the vehicle, based on a fact that the external electronic device is located in the specified area, and a user input to the button is maintained for a specified time or longer than the specified time.

For example, the vehicle control method according to various exemplary embodiments of the present disclosure may include an operation of receiving a signal indicating whether a user input to the external electronic device is maintained for a specified time or longer, through a communication circuit.

For example, the vehicle control method may include an operation of temporarily interrupting function execution based on the external electronic device not being located in a specified area of the surrounding area, or a user input to a button included in the external electronic device being maintained for less than a specified time.

For example, the vehicle control method may include an operation of causing a headlamp of the vehicle to blink based on the external electronic device being located in a first specified area corresponding to a front of the vehicle in the surrounding area, and executing a first function of causing a frunk of the vehicle to be opened.

For example, the vehicle control method may include an operation of causing a tail lamp of the vehicle to blink based on the external electronic device being located in a second specified area corresponding to a rear of the vehicle in the surrounding area, and executing a second function of causing a trunk of the vehicle to be opened.

For example, the vehicle control method may include an operation of causing at least one of a right side mirror lamp included in a side mirror of the vehicle, or a lamp located on a right side surface of the vehicle, or any combination thereof to blink based on the external electronic device being located in a third specified area, which corresponds to a right side of the vehicle, in the surrounding area, and executing a third function of causing a right door of the vehicle to be opened.

For example, the vehicle control method may include an operation of causing at least one of a left side mirror lamp included in a side mirror of the vehicle, or a lamp located on a left side surface of the vehicle, or any combination thereof to blink based on the external electronic device being located in a fourth specified area, which corresponds to a left side of the vehicle, in the surrounding area, and executing a fourth function of causing a left door of the vehicle to be opened.

The vehicle control method according to various exemplary embodiments of the present disclosure may include an operation of identifying that the external electronic device is moving from the surrounding area to an area different from the surrounding area. For example, the vehicle control method may include an operation of causing at least one LED included in the external electronic device to blink based on identifying that the external electronic device moves from the surrounding area to an area different from the surrounding area.

For example, the vehicle control method according to various exemplary embodiments of the present disclosure may include an operation of causing a change in a period, at which the at least one LED included in the external electronic device blinks, based on identifying that the external electronic device moves from the surrounding area to an area different from the surrounding area.

For example, the vehicle control method may include an operation of causing at least one LED blinking at a first period to blink at a second period different from the first period, based on identifying that the external electronic device is moving from the surrounding area to an area different from the surrounding area.

For example, the vehicle control method may include an operation of causing at least one LED, which emits light in a first color, to emit light in a second color different from the first color based on identifying that the external electronic device is moving from the surrounding area to an area different from the surrounding area.

For example, the vehicle control method may include an operation of outputting a guide sound indicating that the external electronic device moves from a surrounding area to an area different from the surrounding area, through a speaker included in the vehicle based on identifying that the external electronic device is moving from the surrounding area to an area different from the surrounding area.

The following embodiments may be different from the above-described embodiments.

For example, the vehicle control method may include an operation of causing a tail lamp of the vehicle to blink based on the external electronic device being located in a first specified area corresponding to a front of the vehicle in the surrounding area, and executing a second function of causing a trunk of the vehicle to be opened, if a user input to a button included in the external electronic device is maintained for a specified time or longer than the specified time.

For example, the vehicle control method may include an operation of causing a headlamp of the vehicle to blink based on the external electronic device being located in a first specified area, and executing a first function of causing a frunk of the vehicle to be opened, if a user input to a button included in the external electronic device is maintained for less than a specified time.

For example, the vehicle control method may include an operation of causing a headlamp of the vehicle to blink based on the external electronic device being located in a second specified area corresponding to a rear of the vehicle in the surrounding area, and executing a first function of causing a frunk of the vehicle to be opened, if a user input to a button included in the external electronic device is maintained for a specified time or longer than the specified time.

For example, the vehicle control method may include an operation of causing a tail lamp of the vehicle to blink based on the external electronic device being located in a second specified area, and executing a second function of causing a trunk of the vehicle to be opened, if a user input to a button included in the external electronic device is maintained for less than a specified time.

For example, the vehicle control method may include an operation of causing at least one of a left side mirror lamp included in a side mirror of the vehicle, or a lamp located on a left side surface of the vehicle, or any combination thereof to blink based on the external electronic device being located in a third specified area, which corresponds to a right side of the vehicle, in the surrounding area, and executing a fourth function of causing a left door of the vehicle to be opened, if a user input to a button included in the external electronic device is maintained for a specified time or longer than the specified time.

For example, the vehicle control method may include an operation of causing at least one of a right side mirror lamp included in a side mirror of the vehicle, or a lamp located on a right side surface of the vehicle, or any combination thereof to blink based on the external electronic device being located in a third specified area, and executing a third function of causing a right door of the vehicle to be opened, if a user input to a button included in the external electronic device is maintained for less than a specified time.

For example, the vehicle control method may include an operation of causing at least one of a right side mirror lamp included in a side mirror of the vehicle, or a lamp located on a right side surface of the vehicle, or any combination thereof to blink based on the external electronic device being located in a fourth specified area, which corresponds to a left side of the vehicle, in the surrounding area, and executing a third function of causing a right door of the vehicle to be opened, if a user input to a button included in the external electronic device is maintained for a specified time or longer than the specified time.

For example, the vehicle control method may include an operation of causing at least one of a left side mirror lamp included in a side mirror of the vehicle, or a lamp located on a left side surface of the vehicle, or any combination thereof to blink based on the external electronic device being located in a fourth specified area, and executing a fourth function of causing a left door of the vehicle to be opened, if a user input to a button included in the external electronic device is maintained for less than a specified time.

As described above, the vehicle control method according to various exemplary embodiments of the present disclosure may perform different functions depending on a location of the external electronic device and a user input to a button included in the external electronic device. The vehicle control method may perform different functions depending on the location of the external electronic device, and a user input to a button included in the external electronic device, improving user convenience of the vehicle control apparatus and/or the external electronic device.

FIG. 7 shows an example of a signal flowchart associated with signals transmitted and/or received between a vehicle control apparatus and an external electronic device, according to an exemplary embodiment of the present disclosure.

A vehicle control apparatus 710 of FIG. 7 may include the vehicle control apparatus 100 of FIG. 1 and/or the vehicle control apparatus 210 of FIG. 2. An external electronic device 720 of FIG. 7 may include the external electronic device 220 of FIG. 2.

Hereinafter, an operation performed by the vehicle control apparatus 710 may be understood as being performed by the processor 110 included in the vehicle control apparatus 100 of FIG. 1 and/or the first processor 211 included in the vehicle control apparatus 210 of FIG. 2. Moreover, hereinafter, the operation performed by the external electronic device 720 may be understood as being performed by the second processor 221 included in the external electronic device 220 of FIG. 2.

Referring to FIG. 7, in S701, according to an exemplary embodiment of the present disclosure, the external electronic device 720 may transmit data indicating a location of the external electronic device 720 to the vehicle control apparatus 710. For example, the external electronic device 720 may transmit data indicating the location of the external electronic device 720 to the vehicle control apparatus 710 based on a UWB master/slave.

In S703, according to an exemplary embodiment of the present disclosure, the external electronic device 720 may turn on at least one LED for indicating that the external electronic device 720 enters the surrounding area, based on receiving a signal for causing at least one LED to be turned on from the vehicle control apparatus 710.

In S705, the vehicle control apparatus 710 according to various exemplary embodiments of the present disclosure may determine whether external device is located in specified area, based on receiving data indicating location of external electronic device through first communication circuit 213.

In S707, the vehicle control apparatus 710 according to various exemplary embodiments of the present disclosure may execute a function, which corresponds to a specified area and which is associated with control of the vehicle, based on the external electronic device 720 being located in a specified area of the surrounding area, data indicating a location of the external electronic device 720, and the fact that user input to button is maintained for specified time or longer.

For example, the specified area of the surrounding area of the vehicle may include the first specified area corresponding to the front of the vehicle, the second specified area corresponding to the rear of the vehicle, the third specified area corresponding to the right side of the vehicle, and/or the fourth specified area corresponding to the left side of vehicle.

For example, the function associated with control of the vehicle may include the first function that causes a headlamp of the vehicle to be turned on and causes a frunk of the vehicle to be opened. For example, the function associated with control of the vehicle may include the second function that causes a tail lamp of the vehicle to be turned on and causes a trunk of the vehicle to be opened. For example, the function associated with control of the vehicle may include the third that causes at least one of a right side mirror lamp included in the side mirror of the vehicle, or a lamp located on the right side surface of the vehicle, or any combination thereof to be turned on, and causes a right door of the vehicle to be opened. For example, the function associated with control of the vehicle may include the fourth that causes at least one of a left side mirror lamp included in the side mirror of the vehicle, or a lamp located on the left side surface of the vehicle, or any combination thereof to be turned on, and causes a left door of the vehicle to be opened.

According to an exemplary embodiment of the present disclosure, the external electronic device 720 may transmit a signal associated with a user input to a button included in the external electronic device 720 to the vehicle control apparatus 710. For example, the signal associated with the user input to the button may include information associated with at least one of the presence or absence of a user input to the button, or a time in which a user input to the button is maintained, or any combination thereof.

The vehicle control apparatus 710 according to various exemplary embodiments of the present disclosure may receive a signal associated with the user input to the button from the external electronic device 720. The vehicle control apparatus 710 may be configured to determine whether a user input to a button is maintained for a specified time or longer, based on the signal associated with a user input to the button.

For example, the vehicle control apparatus 710 may execute a function associated with control of the vehicle at a location corresponding to a point in time, at which the user input is performed, based on the user input to the button being maintained for the specified time or longer than the specified time.

FIG. 8 shows an example of a computing system associated with a vehicle control apparatus or vehicle control method, according to an exemplary embodiment of the present disclosure.

Referring to FIG. 8, a computing system 1000 may include at least one processor 1100, a memory 1300, a user interface input device 1400, a user interface output device 1500, storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Accordingly, the processes of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed based on the accompanying claims, and all the technical ideas within the scope equivalent to the claims should be included in the scope of the present disclosure.

The present technology may execute different functions depending on a relative location of an external electronic device with respect to a vehicle.

Moreover, the present technology may execute different functions depending on a relative location of the external electronic device with respect to the vehicle, and an input to a button included in the external electronic device.

Furthermore, the present technology may provide a notification of a function performed if a user input to a location of the external electronic device, and a button included in the external electronic device is generated.

Besides, a variety of effects directly or indirectly understood through the present disclosure may be provided.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle control apparatus comprising:
a communication circuit; and
a processor operatively connected to the communication circuit,
wherein the processor is configured to:
determine whether an external electronic device is located in a surrounding area formed within a predetermined distance from a vehicle, based on receiving data associated with a location of the external electronic device from the external electronic device, through the communication circuit; and
execute a function, which corresponds to a predetermined area and which is associated with control of the vehicle, based on a fact that the external electronic device is located in the predetermined area of the surrounding area, and a user input to a button included in the external electronic device is maintained for a predetermined time or longer than the predetermined time.

2. The vehicle control apparatus of claim 1,
wherein the predetermined area includes a first predetermined area,
wherein the function includes a first function, and
wherein the processor is further configured to:
cause a headlamp of the vehicle to blink based on the external electronic device being located in the first predetermined area corresponding to a front of the vehicle in the surrounding area; and
execute the first function of causing a frunk of the vehicle to be opened.

3. The vehicle control apparatus of claim 1,
wherein the predetermined area includes a second predetermined area,
wherein the function includes a second function, and
wherein the processor is further configured to:
cause a tail lamp of the vehicle to blink based on the external electronic device being located in the second predetermined area corresponding to a rear of the vehicle in the surrounding area; and
execute the second function of causing a trunk of the vehicle to be opened.

4. The vehicle control apparatus of claim 1,
wherein the predetermined area includes a third predetermined area,
wherein the function includes a third function, and
wherein the processor is further configured to:
cause at least one of a right side mirror lamp included in a side mirror of the vehicle, or a lamp located on a right side surface of the vehicle, or any combination thereof to blink based on the external electronic device being located in the third predetermined area, which corresponds to a right side of the vehicle, in the surrounding area; and
execute the third function of causing a right door of the vehicle to be opened.

5. The vehicle control apparatus of claim 1,
wherein the predetermined area includes a fourth predetermined area,
wherein the function includes a fourth function, and
wherein the processor is further configured to:
cause at least one of a left side mirror lamp included in a side mirror of the vehicle, or a lamp located on a left side surface of the vehicle, or any combination thereof to blink based on the external electronic device being located in the fourth predetermined area, which corresponds to a left side of the vehicle, in the surrounding area; and
execute the fourth function of causing a left door of the vehicle to be opened.

6. The vehicle control apparatus of claim 1, wherein the processor is further configured to:
cause at least one light-emitting diode (LED) included in the external electronic device to blink based on identifying that the external electronic device moves from the surrounding area to an area different from the surrounding area.

7. The vehicle control apparatus of claim 6, wherein the processor is further configured to:
cause the at least one LED blinking at a first period to blink at a second period different from the first period based on identifying the moving.

8. The vehicle control apparatus of claim 6, wherein the processor is further configured to:
cause the at least one LED emitting light in a first color to emit light in a second color different from the first color based on identifying the moving.

9. The vehicle control apparatus of claim 1, wherein the processor is further configured to:
output a guide sound indicating that the external electronic device moves from the surrounding area to an area different from the surrounding area, through a speaker included in the vehicle based on identifying that the external electronic device moves from the surrounding area to the area different from the surrounding area.

10. A vehicle control system comprising:
a vehicle control apparatus included in a vehicle; and
an external electronic device including a smart key,
wherein the vehicle control apparatus includes:
a first communication circuit configured to establish a communication link with the external electronic device; and
a first processor operatively connected to the first communication circuit, wherein the external electronic device includes:
a second communication circuit configured to establish a communication link with the vehicle control apparatus;
at least one light emitting diode (LED);
a button; and
a second processor operatively connected to the second communication circuit,
wherein the second processor is configured to:
transmit data indicating a location of the external electronic device to the vehicle control apparatus through the second communication circuit; and
turn on the at least one LED for indicating that the external electronic device enters a surrounding area formed within a predetermined distance from the vehicle, based on receiving a signal for causing the at least one LED to be turned on from the vehicle control apparatus, and
wherein the first processor is configured to:
determine whether the external electronic device is located in a predetermined area of the surrounding area, based on receiving data indicating the location of the external electronic device through the first communication circuit; and
execute a function, which corresponds to the predetermined area and which is associated with control of the vehicle, based on a fact that the external electronic device is located in the predetermined area, and a user input to the button is maintained for a predetermined time or longer than the predetermined time.

11. The vehicle control system of claim 10, wherein the predetermined area includes a first predetermined area corresponding to a front of the vehicle, a second predetermined area corresponding to a rear of the vehicle, a third predetermined area corresponding to a right side of the vehicle, and a fourth predetermined area corresponding to a left side of vehicle.

12. The vehicle control system of claim 10, wherein the function associated with the control of the vehicle includes:
a first function that causes a headlamp of the vehicle to be turned on and causes a frunk of the vehicle to be opened;
a second function that causes a tail lamp of the vehicle to be turned on and causes a trunk of the vehicle to be opened;
a third function that causes at least one of a right side mirror lamp included in a side mirror of the vehicle, or a lamp located on a right side surface of the vehicle, or any combination thereof to be turned on, and causes a right door of the vehicle to be opened; and
a fourth function that causes at least one of a left side mirror lamp included in a side mirror of the vehicle, or a lamp located on a left side surface of the vehicle, or any combination thereof to be turned on, and causes a left door of the vehicle to be opened.

13. The vehicle control system of claim 10,
wherein the first processor is further configured to:
identify that the external electronic device moves from the surrounding area to an area different from the surrounding area, based on data indicating the location of the external electronic device, through the first communication circuit; and
transmit a signal for causing a change in a period, at which the at least one LED included in the external electronic device blinks, to the external electronic device based on identifying the moving, and
wherein the second processor is further configured to:
change the period, at which the at least one LED blinks, from a first period to a second period based on receiving the signal for causing the change in the period, at which the at least one LED blinks.

14. A vehicle control method, the method including:
determining, by a processor, whether an external electronic device is located in a surrounding area formed within a predetermined distance from a vehicle, based on receiving data associated with a location of the external electronic device from the external electronic device, through a communication circuit; and
executing a function, which corresponds to the predetermined area and which is associated with control of the vehicle, based on a fact that the external electronic device is located in the predetermined area, and a user input to a button is maintained for a predetermined time or longer than the predetermined time.

15. The method of claim 14,
wherein the predetermined area includes a first predetermined area,
wherein the function includes a first function, and
wherein the method further includes:
causing a headlamp of the vehicle to blink based on the external electronic device being located in the first predetermined area corresponding to a front of the vehicle in the surrounding area; and
executing the first function of causing a frunk of the vehicle to be opened.

16. The method of claim 14,
wherein the predetermined area includes a second predetermined area,
wherein the function includes a second function, and
wherein the method further includes:
causing a tail lamp of the vehicle to blink based on the external electronic device being located in the second predetermined area corresponding to a rear of the vehicle in the surrounding area; and
executing the second function of causing a trunk of the vehicle to be opened.

17. The method of claim 14,
wherein the predetermined area includes a third predetermined area,
wherein the function includes a third function, and
wherein the method further includes:
causing at least one of a right side mirror lamp included in a side mirror of the vehicle, or a lamp located on a right side surface of the vehicle, or any combination thereof to blink based on the external electronic device being located in the third predetermined area, which corresponds to a right side of the vehicle, in the surrounding area; and
executing the third function of causing a right door of the vehicle to be opened.

18. The method of claim 14,
wherein the predetermined area includes a fourth predetermined area,
wherein the function includes a fourth function, and
wherein the method further includes:
causing at least one of a left side mirror lamp included in a side mirror of the vehicle, or a lamp located on a left side surface of the vehicle, or any combination thereof to blink based on the external electronic device being located in the fourth predetermined area, which corresponds to a left side of the vehicle, in the surrounding area; and
executing the fourth function of causing a left door of the vehicle to be opened.

19. The method of claim 14, further including:
causing at least one LED included in the external electronic device to blink based on identifying that the external electronic device moves from the surrounding area to an area different from the surrounding area.

20. The method of claim 19, further including:
causing the at least one LED blinking at a first period to blink at a second period different from the first period based on identifying the moving.
